(19) United States
(12) Patent Application Publication
(10) Pub. No.: US 2007/0063829 A1
(43) Pub. Date: Mar. 22, 2007

(54) Battery-less tire pressure monitoring system

(75) Inventors: Chao-Heng Chien, Taipei City (TW); Ying-Chun Yu, Taipei City (TW)

Correspondence Address: BACON & THOMAS, PLLC, 625 SLATERS LANE, FOURTH FLOOR, ALEXANDRIA, VA, 22314, US

(73) Assignees: Kuender Co., Ltd., Taipei City (TW); Tatung Company, Taipei City (TW); Lenghways Technology Co., Ltd., Taipei City (TW)

(21) Appl. No.: 11/345,322

(22) Filed: Feb. 2, 2006

(30) Foreign Application Priority Data
Sep. 22, 2005 (TW) 094132814

(51) Int. Cl. B60C 23/00

(52) U.S. Cl. 340/447

(57) ABSTRACT

A battery-less tire pressure monitoring system is disclosed, which is installed in a tire to monitor the status of the tire, such as the air pressure of the tire. The battery-less TPMS has a tire pressure sensor, and a power generation device, wherein the tire pressure sensor is installed on the fixture in the tire, in order to monitor the status of the tire. Besides, the power generation device of the battery-less TPMS is also installed on the fixture of the tire, and is electrically connected with the tire pressure sensor to provide electrical power for the operation of the tire pressure sensor.

### BACKGROUND OF THE INVENTION

1. Field of the Invention

The present invention relates to a tire pressure monitoring system (TPMS), in particular, to a battery-less tire pressure monitoring system.

2. Description of Related Art

In November 2003, the government of the United States issued a law requiring that a certain amount of the newly manufactured vehicles should be equipped with a tire pressure monitoring system (TPMS). Furthermore, the law also requires that after Sep. 1, 2007, all the newly manufactured vehicles should be equipped with the TPMS. As a result, more and more vehicles manufacturers have developed many different kinds of TPMS to meet this increasing requirement. Currently, there are two types of TPMS, which are the direct type TPMS and the indirect type TPMS, respectively. In the direct type TPMS, the tire pressure sensor is installed in a tire; while in the indirect type TPMS, the pressure change of atmosphere in the tire is monitored through the measurement of the gyration of area of the tire by the anti-lock breaking system (ABS).

The direct type TPMS described above comprises a tire pressure sensor, a tire temperature sensor, a transmitter and a battery set, which are each mounted in the tire. Therefore, although the direct type TPMS can provide measured values with high accuracy, there are still some unavoidable disadvantages related to the installation of the battery set, which are as described below:

1. To replace the battery set of the direct TPMS, the entire tire having the direct TPMS should be removed from the wheel rim.

2. To elongate the life time of the battery set, the direct TPMS will automatically switch to its “energy save mode” from time to time. Thus, the direct TPMS cannot provide consistent and real-time monitoring on the status of the tire, such as the tire pressure and the tire temperature.

3. Since the battery set of the direct TPMS is installed in the tire, the performance of the battery set is easily influenced by the temperature of the tire, especially when the temperature of the tire is too high or too low.

Therefore, it is desirable to provide an improved TPMS, especially a battery-less TPMS, to obviate the aforementioned problems.

### SUMMARY OF THE INVENTION

It is one object of the present invention to provide a battery-less tire pressure monitoring system, which can to avoid the system failure of the TPMS priorly arising from the overheating of the battery set installed in the tire.

It is another object of the present invention to provide a battery-less TPMS, which can avoid the inconvenience of the replacement operation of the battery set of the TPMS.

It is still another object of the present invention to provide a battery-less TPMS, which can provide real-time monitoring on the tire pressure status due to consistent power supply.

To accomplish the above objects, the battery-less TPMS of the present invention is installed in a tire comprising a fixture and an inner space, wherein the battery-less TPMS of the present invention comprises: a tire pressure sensor and a power generation device. The tire pressure sensor is installed on the fixture in the tire, in order to monitor the status of the tire. Besides, the power generation device and the tire pressure sensor of the battery-less TPMS of the present invention are mounted on the fixture together, and the tire pressure sensor is electrically connected with the power generation device.

Moreover, the power generation device of the battery-less TPMS of the present invention further comprises a fan located in the inner space of the tire. Besides, the power generation device generates the electrical power to the tire pressure sensor through the rotation of the fan caused by the relative movement between the fan mounted on the fixture and an atmosphere in the inner space of the tire when the tire is rotated. The fixture of the tire can be a tire wheel, and the fan and the power generation device can be installed at different locations of the tire wheel, or the fan and the power generation device can be installed adjacently on tire wheel. Moreover, the height of the fan can be one-half of the height between the fixture (tire wheel) and the tire skin of the tire. Or, alternatively, the height of the fan can be smaller than the height of the side edge of the tire wheel of the tire.

The tire pressure sensor of the battery-less TPMS of the present invention comprises at least one sensor, a transmitter and a micro control unit (MCU), wherein the MCU is electrically connected with the at least one sensor and the transmitter, respectively. The at least one sensor monitors the pressure and the temperature of the tire and obtains one measured value. Then, the measured value is processed by the MCU and transmitted to a receiving terminal through the transmitter. Besides, the fixture of the tire can be a tire wheel or a tire valve of the tire.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of the battery-less tire pressure monitoring system according to the first preferred embodiment of the present invention;

FIG. 2 is a schematic view of the battery-less tire pressure monitoring system according to the first preferred embodiment of the present invention, which shows the tire pressure sensor and the power generation device being installed adjacently on the fixture of a tire;

FIG. 3 is another schematic view of the battery-less tire pressure monitoring system according to the first preferred embodiment of the present invention, which shows the tire pressure sensor and the power generation device being installed on different positions of the fixture of a tire;

FIG. 4 is a functional diagram of the battery-less tire pressure monitoring system according to the first preferred embodiment of the present invention;

FIG. 5 is a schematic view of the battery-less tire pressure monitoring system according to the second preferred embodiment of the present invention.

### DETAILED DESCRIPTION OF THE PREFERRED EMBODIMENT

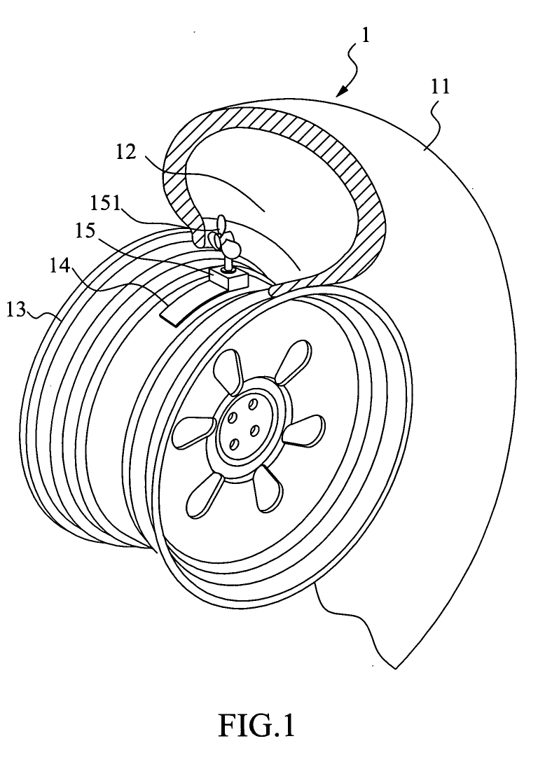

The battery-less tire pressure monitoring system according to the first preferred embodiment of the invention is explained in more detail hereinafter with reference to FIG. 1 of the present invention. As shown in FIG. 1, a tire 1 comprises a tire skin 11 and a fixture 13, wherein an inner space 12 is formed between the tire skin 11 and the fixture 13. In the present preferred embodiment of the present invention, the fixture 13 is a tire wheel. Moreover, a tire pressure sensor 14 and a power generation device 15 are mounted on the fixture 13, wherein the power generation device 15 is electrically connected with the tire pressure sensor 14. Besides, the power generation device 15 comprises a fan 151 located in the inner space 12. In the present preferred embodiment of the present invention, the height of the fan 151 is one-half of the height between the fixture 13 (tire wheel) and the tire skin 11. However, in other preferred embodiments of the present invention, the height of the fan 151 can be smaller than the height of the side edge of tire wheel.

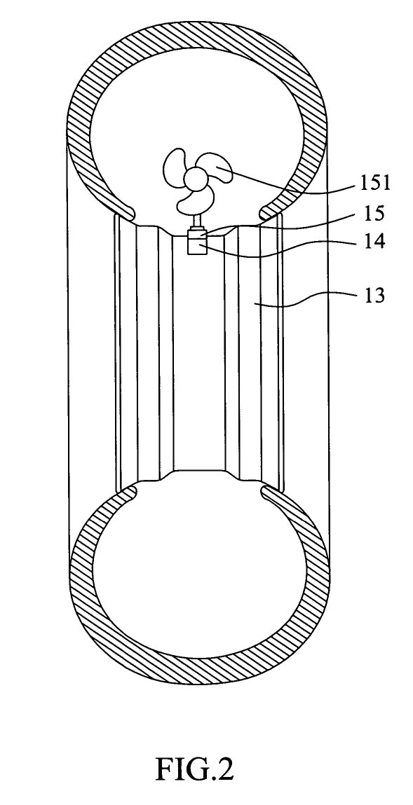

FIG. 2 is a schematic view of the battery-less tire pressure monitoring system according to the first preferred embodiment of the present invention, which shows that the tire pressure sensor 14 and the power generation device 15 installed adjacently on the fixture 13 of a tire. As shown in FIG. 2, the fan 151 is installed on the power generation device 15 and the tire pressure sensor 14, the power generation device 15 and the fan 151 are all mounted on the same side of the fixture 13 of the tire. This unbalanced installation will make the weight of the fixture 13 almost impossible to be equally distributed. As a result, the dynamic equilibrium of the tire is extremely difficult to be achieved when the tire is rotated.

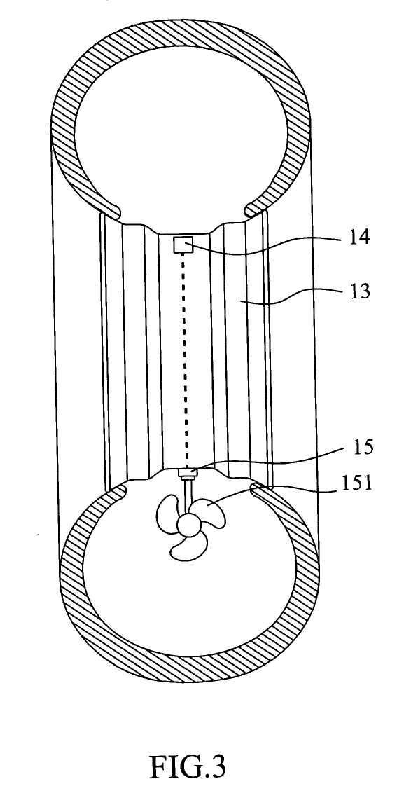

FIG. 3 is another schematic view of the battery-less tire pressure monitoring system according to the first preferred embodiment of the present invention, which shows the tire pressure sensor 14 and the power generation device 15 being installed on different positions of the fixture 13 of a tire. As shown in FIG. 3, the power generation device 15 is electrically connected with the tire pressure sensor 14 and provides the electrical power to the tire pressure sensor 14.

The power generation device 15 described above generates electrical power mainly through the rotation of the fan 151 installed thereon. Since the fan 151 is mounted on the power generation device 15 and located in the inner space 12 between the tire skin 11 and the fixture 13 of the tire 1, the fan 151 rotates due to the relative movement between the atmosphere in the inner space 12 and the fan 151 when the tire 1 is rotated. When the fan 151 rotates, the power generation device 15 generates electrical power to the tire pressure sensor 14 as a result. Therefore, the tire pressure sensor 14 of the battery-less TPMS of the present invention can real-time monitor the status of the tire 1 while tire 1 is rotating. Thus, the monitoring frequency of tire pressure sensor 14 of the battery-less TPMS of the present invention can be increased significantly.

The tire pressure sensor 14 of the battery-less TPMS of the present invention can not only monitor the pressure of the tire, but also monitor the temperature and other statuses of the tire. The detailed descriptions relating to the tire pressure sensor 14 are described hereinafter.

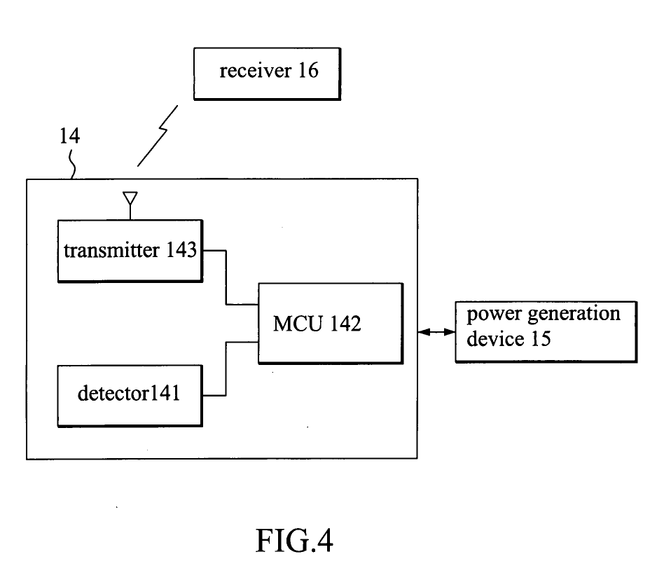

FIG. 4 is a functional diagram of the battery-less tire pressure monitoring system according to the first preferred embodiment of the present invention. The tire pressure sensor 14 of the present invention comprises a detector 141, a micro control unit (MCU) 142, and a transmitter 143, wherein the tire pressure sensor 14 receives the electrical power generated by the power generation device 15 for operational use. Moreover, the MCU 142 is electrically connected with the detector 141 and the transmitter 142, respectively.

In the present preferred embodiment of the present invention, the detector 141 can comprise one or more than one detector, in order to monitor the pressure and temperature of the tire 1. Thus, the detector 141 can obtain at least one measured value of the status of the tire 1. Then, the MCU 142 can perform the signal-processing processes to the measured value obtained by the detector 141, and the result of the signal-processing process is transmitted to a remote receiver 16 through the transmitter 143. In the present preferred embodiment of the present invention, the transmitter 143 can be a wireless transmitting module, which can transmit the results signal-processing processes of the MCU 142 to the receiver 16 through a radio frequency (RF) band. Moreover, the receiver 16 can be integrated with the display device of a vehicle having the battery-less TPMS of the present invention. In other words, after receiving the result of the signal-processing processes of the MCU 142, the receiver 16 might transfer the result to an on-board center control computer or a control unit, and the result, such as all kinds of the status of the tire, can then be displayed on a display device installed on the vehicle.

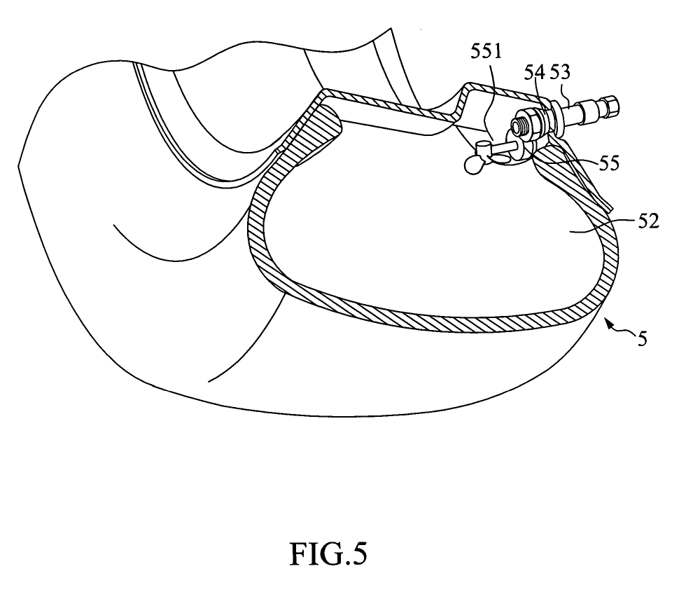

FIG. 5 is a schematic view of the battery-less tire pressure monitoring system according to the second preferred embodiment of the present invention. As shown in FIG. 5, a tire pressure sensor 54 and a power generation device 55 are mounted on a fixture 53 of a tire 5. In this preferred embodiment of the present invention, the fixture 53 is a tire valve. It is to be noted that a fan 551 of the power generation device 55 of the battery-less TPMS according to the present embodiment is located in an inner space 52 of the tire 5. Thus, when the tire 5 is rotated, the power generation device 55 can generate electrical power through the rotation of the fan 551 due to the relative movement between the fan 551 mounted on the fixture 53 and an atmosphere in the inner space 52 of the tire 5.

In summary, the present invention provides a battery-less tire pressure monitoring system (TPMS), the power generation device of which generates electrical power through the rotation of the fan installed thereon, in order to supply electrical power to the tire pressure monitoring system of the present invention. Therefore, the battery-less TPMS of the present invention can avoid the prior art system failure of the TPMS due to the overheating of the battery installed in the tire, and the inconvenience of the replacement operations of the battery set installed in the tire can also be avoided. Moreover, the battery-less TPMS of the present invention can provide real-time monitoring on the tire pressure due to consistent electrical power supply, and thus the monitoring frequency of the battery-less TPMS of the present invention can also be increased significantly.

Although the present invention has been explained in relation to its preferred embodiment, it is to be understood that many other possible modifications and variations can be made without departing from the scope of the invention as hereinafter claimed.

What is claimed is:

1. A battery-less tire pressure monitoring system installed in a tire comprising a fixture and an inner space, wherein the battery-less tire pressure monitoring system comprises:
a tire pressure sensor installed on the fixture, wherein the tire pressure sensor monitors the air pressure of the tire; and
a power generation device installed on the fixture together with the tire pressure sensor, wherein the power generation device is electrically connected with the tire pressure sensor.

2. The battery-less tire pressure monitoring system as claimed in claim 1, wherein the power generation device further comprises a fan located in the inner space of the tire, whereby, when the tire is rotated, the power generation device generates electrical power to the tire pressure sensor through the rotation of the fan caused by the relative movement between the fan mounted on the fixture and an atmosphere in the inner space of the tire.

3. The battery-less tire pressure monitoring system as claimed in claim 2, wherein the tire further comprises a tire skin, and the inner space of the tire is between the fixture and the tire skin; and, the height of the fan is one-half of the height between the fixture and the tire skin.

4. The battery-less tire pressure monitoring system as claimed in claim 2, wherein the tire further comprises a tire skin, and the inner space of the tire is between the fixture and the tire skin; the fixture is a tire wheel and the height of the fan is smaller than the height of a side edge of the tire wheel.

5. The battery-less tire pressure monitoring system as claimed in claim 1, wherein the fixture is a tire wheel.

6. The battery-less tire pressure monitoring system as claimed in claim 1, wherein the fixture is a valve.

7. The battery-less tire pressure monitoring system as claimed in claim 1, wherein the tire pressure sensor comprises at least one sensor, a transmitter and a micro control unit (MCU), wherein the MCU is electrically connected with the at least one sensor and the transmitter, respectively; the at least one sensor monitors the air pressure and the temperature of the tire and obtains measured values; and, the measured values are processed by the MCU and are transmitted to a receiving terminal.

8. The battery-less tire pressure monitoring system as claimed in claim 5, wherein the power generation device and tire pressure sensor are mounted on different positions of the tire wheel.

9. The battery-less tire pressure monitoring system as claimed in claim 5, wherein the power generation device and tire pressure sensor are mounted adjacently on the tire wheel.
